(19) United States
(12) Patent Application Publication
(10) Pub. No.: US 2018/0029398 A1
(43) Pub. Date: Feb. 1, 2018

(54) METHOD AND APPARATUS FOR MARKING A PACKAGE OF ARTICLES

(71) Applicant: JT INTERNATIONAL S.A., Geneva (CH)

(72) Inventor: Jens FRANZEN, Hentern (DE)

(73) Assignee: JT International S.A., Geneva (CH)

(21) Appl. No.: 15/549,898

(22) PCT Filed: Feb. 3, 2016
(86) PCT No.: PCT/EP2016/052264

§ 371 Date: Aug. 9, 2017

(30) Foreign Application Priority Data
Feb. 10, 2015 (EP) 15154536.5

(51) Int. Cl. B41M 5/26; B65B 19/22; B65D 85/10; B65D 77/00; B65D 77/22; B65B 17/00; B65B 61/26

(52) U.S. Cl. CPC B41M 5/267; B65B 17/00; B65B 19/22; B65B 61/26; B65D 77/003; B65D 77/22; B65D 85/10

(57) ABSTRACT

A method of marking a package of articles, especially consumer articles, such as cigarettes or the like, includes providing a package of one or more article and a first wrapping material. The package is wrapped with the first wrapping material. A marking is provided on a region of the enclosure. The step of providing a marking on the region of the enclosure includes irradiating the wrapped package with a laser beam, and the first wrapping material is substantially transparent to the laser beam, at least in the region to be marked. An apparatus for marking a package of articles, such as a pack of cigarettes, is also described.

The present invention relates to a method and apparatus for marking a package of articles, especially consumer articles, such as smoking articles including cigarettes or the like, or other consumables. The present invention also provides a marked package of articles obtained by such a method and/or apparatus.

The method and apparatus of the invention is especially suited to the processing and marking of packs of smoking articles, such as cigarette packs or the like, and particularly to the provision of a product code and/or product data, such as a batch number or expiry data specific to the packaged article(s). The package itself may typically take the form of a carton, container, or box, preferably made of paper or card, although other materials may also be contemplated. Importantly, however, it will be noted that the method and apparatus of the invention are not limited to this packaging application, but may be suited to, and employed for, marking a package of a range of other articles, especially consumer articles.

Conventionally, cigarette packs are separately or individually wrapped in a clear plastic or polymer film to seal and protect the packs against external influences, such as moisture and dust, and to maintain the freshness of the product therein. Furthermore, the individual cigarette packs are typically additionally grouped (e.g. into groups of 10) and then wrapped as a group in a clear plastic or polymer film prior to being packaged again as a group in a larger carton or box. As it is useful and desirable to mark not only individual cigarette packs, but collected or bundled groups of those packs as well, the present invention is directed to the task of providing a new and improved concept for a method and apparatus of marking packages that is particularly suited to packs of smoking articles. The marking concept should desirably be convenient and user-friendly and be adaptable to both individual packs and to collected or bundled groups of packs.

In accordance with the invention, a method of marking a package of one or more articles having the features as recited in claim 1 is provided. Further, the invention provides an apparatus for marking a package of one or more articles having the features as recited in claim 13. A number of preferred or advantageous features of the invention are recited in the dependent claims.

According to one aspect, therefore, the invention provides a method of marking a package of articles, especially consumer articles, such as cigarettes or the like, the method comprising:
providing at least one package of one or more articles, wherein the package comprises an enclosure, especially a container, that accommodates the one or more articles;
providing a first wrapping material and wrapping the package with the first wrapping material;
providing a marking on a region of the enclosure after wrapping the package with the first wrapping material;
wherein the step of providing a marking on the region of the enclosure includes irradiating the wrapped package with a laser beam, wherein the first wrapping material is substantially transparent to the laser beam, at least in the region to be marked.

In this way, the invention provides a method with which it is possible to perform the desired marking of the package, and particularly the enclosure or container of the package, after the package has been wrapped with the first wrapping material. In this regard, it will be appreciated that the step of wrapping the package with the first wrapping material comprises covering at least the region of the package to be marked with the first wrapping material, and typically substantially entirely covering and/or enclosing the package with the first wrapping material. Thus, the marking of the package enclosure occurs through the first wrapping material, in particular via the laser beam. The invention is also advantageous in enabling the marking of a package to occur after the wrapping step because after wrapping some packages may be rejected due to an inadequate quality of the wrapping. Thus, in the event the marking includes a code for tracking a package, such as a cigarette pack, from a production or manufacturing site to retail consumer, the inventive method allows a defective wrapped package to be removed prior to marking. This is significant as a database of tracking codes need not be amended or updated to record the fact that a package or pack pre-marked with a code has subsequently been rejected.

In a preferred embodiment, the region of the enclosure to be marked includes a surface or coating which is sensitive to irradiation with the laser beam, such that the light of the laser beam marks that region. Thus, the step of providing a marking on the region typically comprises irradiating the region to be marked in a particular pattern or design in order to inscribe, print or provide the marking with the desired information. In this regard, the laser beam may be moved over the region to trace or inscribe the desired information of the marking. Alternatively, the laser beam may be irradiated or projected as an image, e.g. through a stencil, diaphragm, or screen, which contains the desired marking. To this end, a surface of the region to be marked may preferably include a coating, such as an ink layer, that is sensitive to the laser beam. That is, the coating or surface may react to the light irradiated with laser beam to form a mark on the surface of the package. For example, the laser beam may act to remove an ink layer in the region to be marked to expose a substrate of a different colour below the ink, such that the contrast between the colour of the ink and the colour of the substrate provides a readily visible marking. The marking provided or formed with the laser beam may preferably comprise a code and/or data specific to the packaged article(s), such as a production batch number and/or expiry data.

In a preferred embodiment, the first wrapping material is substantially unaffected by the laser beam; that is, the first wrapping material is preferably neither burnt nor broken by the laser beam. Expressed another way, the laser beam is desirably selected such that it does not substantially affect the first wrapping material, e.g. such that it does not perforate or burn or cut the first wrapping material. In this regard, the first wrapping material is preferably a polymer film which comprises a material that is selected from the group consisting of polypropylene, polyethylene, polyester, polyvinylchloride, and bio-plastic, such as polylactic acid, cellulose acetate, and cellophane. In this regard, it will be appreciated that the first wrapping material is preferably a film laminate or a layered film in which one or more of the above materials is present and/or predominates. In a particularly preferred form, the first wrapping material is a film laminate comprising polypropylene (such as an oriented polypropylene) with one or more acrylic layers (such as an inner layer or coating and/or an outer layer or coating of acrylic). The first wrapping material is desirably provided in a sheet or web for wrapping the at least one package.

In a preferred embodiment, the package, and especially the enclosure or container of the package, comprises a material selected from the group consisting of: paper, card, and cardboard. Thus, the laser beam is preferably configured to mark the paper, card, or cardboard of the package through the first wrapping material. In an alternative embodiment, a plastic material could be contemplated for the package.

In a preferred embodiment, the laser beam with which the wrapped package is irradiated to provide the marking on the region of the enclosure has a wavelength in the range of 1000 to 1100 micrometres (μm), and particularly preferably of about 1062 micrometres (μm). Furthermore, the laser beam desirably has a power in the range of about 1 Watt to about 100 Watt, more preferably in the range of about 20 Watt to about 50 Watt, and most preferably of about 30 Watt. The laser beam is preferably irradiated onto the wrapped package via one or more wave guide, and especially via one or more optical fibre. In this regard, the laser is preferably a fibre laser.

In a particularly preferred embodiment, a plurality of the packages are provided and wrapped with the first wrapping material, especially individually or separately wrapped with the first wrapping material. The method may then further comprise:
collecting or arranging the plurality of wrapped packages into a group; and
providing a second wrapping material and wrapping the group of wrapped packages with the second wrapping material before the step of providing a marking on a region of the enclosure of at least one, and preferably each, wrapped package; wherein the second wrapping material is substantially transparent to the laser beam, at least in each region to be marked. Thus, in this embodiment the marking of an individual package enclosure occurs through both the first wrapping material and the second wrapping material which wraps the group, in particular via the laser beam. This embodiment is advantageous because, in the event that the marking includes a tracking code for tracking a package, such as a cigarette pack, from production to retail, the method allows packages that have been defectively wrapped with the first wrapping material to be removed from the production path prior to the step of collecting or arranging the plurality of wrapped packages into a group to be wrapped with a second wrapping material marking. This is significant because the tracking codes then need only be applied after the group is wrapped and no codes are lost with rejected, defectively wrapped individual packs after the first wrapping step. Accordingly, there is no need to update a database of tracking codes after a pack pre-marked with a code has been rejected. The marking is only applied to wrapped packages which satisfy the quality requirements.

In an alternative embodiment, however, the method may further comprise:
collecting or arranging the plurality of wrapped packages into a group; and
providing a second wrapping material and wrapping the group of wrapped packages with the second wrapping material after the step of providing a marking on a region of the enclosure of each wrapped package. Thus, in this embodiment the marking of each individual package occurs through the first wrapping material and thereafter the plurality of wrapped packages are collected or bundled into a group using the second wrapping material. Again, the second wrapping material is preferably substantially transparent to the laser beam. In this way, a marking may also be provided on the group or bundle of wrapped packages via the laser beam after wrapping the group of wrapped packages with the second wrapping material. In such a case, the marking would then also occur through both the first wrapping material and the second wrapping material which wraps the group.

As discussed above in respect of the first wrapping material, the second wrapping material is preferably also substantially unaffected by the laser beam, in particular the second wrapping material may be neither burnt nor broken by the laser beam. In this regard, the second wrapping material is preferably a polymer film which comprises a material that is also selected from the group of polypropylene (PP), polyethylene (PE), polyester, polyvinylchloride (PVC) and bio-plastic, such as polylactic acid (PLA), cellulose acetate, and cellophane. In this regard, it will be appreciated that the second wrapping material is preferably a layered film or a film laminate in which one or more of the above materials is present or predominates. In a particularly preferred embodiment, the second wrapping material is a laminate film comprising a layer of polypropylene (e.g. an oriented polypropylene) and one or more acrylic layers (e.g. an inner layer or coating of acrylic and/or an outer layer or coating of acrylic). Thus, the second wrapping material may optionally comprise the same material as the first wrapping material. The first wrapping material and the second wrapping material are typically transparent in the visible light spectrum to enable a consumer to see and read the marking through the wrapping material.

According to another aspect, the present invention provides a wrapped package of one or more articles, wherein the package comprises a laser marking obtained by a method according to any one of the embodiments described above, wherein the articles preferably comprise smoking articles, such as cigarettes or the like. In a preferred embodiment, the invention provides a plurality of wrapped packages that are grouped together and wrapped as a group, wherein each package comprises a laser marking obtained by the method of the invention described above.

According to a further aspect, the invention provides an apparatus for marking a package of articles, especially consumer articles, such as cigarettes or the like, the apparatus comprising:
a wrapping unit configured to wrap at least one package of one or more articles with a wrapping material, each package comprising an enclosure, especially a container, that accommodates the one or more articles, wherein the wrapping material substantially covers or encompasses the enclosure;
a marking unit comprising a laser for irradiating the wrapped package with a laser beam to provide a marking on a region of the enclosure, wherein the wrapping material is substantially transparent to the laser beam, at least in the region to be marked.

In a preferred embodiment, the apparatus comprises a bundling unit for collecting and/or arranging a plurality of packages into a group and wrapping the group of packages in the wrapping material, as discussed above. The bundling unit is optionally comprised in the wrapping unit. Preferably, each of the plurality of packages is pre-wrapped with a first wrapping material that is substantially transparent to the laser beam, at least in the region to be marked; that is, each package may be individually or separately pre-wrapped with the first wrapping material. Thus, the bundling unit is preferably configured to wrap the group of packages in a second the wrapping material that is also substantially transparent to the laser beam, at least in the region to be marked. As discussed above, the first and second wrapping material is preferably a polymer film which comprises a material selected from the group consisting of polypropylene (PP), polyethylene (PE), polyester, polyvinylchloride (PVC) and bio-plastic, such as polylactic acid (PLA), cellulose acetate, and cellophane. Thus, the second wrapping material may optionally comprise the same material as the first wrapping material.

Thus, in a preferred embodiment, the invention provides an apparatus for marking packages of articles, especially packs of consumer articles, such as cigarettes or the like, the apparatus comprising:
a wrapping unit configured to wrap packages of one or more articles with a wrapping material, each package comprising an enclosure, especially a container, that accommodates the one or more articles, wherein the wrapping unit includes a bundling unit for collecting and/or arranging a plurality of the packages into a group before wrapping the group of packages with the wrapping material;
a marking unit comprising a laser for irradiating at least one, and preferably all, of the wrapped packages with a laser beam to provide a marking on a region of the respective enclosure, the wrapping material being substantially transparent to the laser beam, at least in each region to be marked.

As noted already above, the laser generates a laser beam which preferably has a wavelength in the range of 1000 to 1100 micrometres, and particularly preferably of about 1062 micrometres. Furthermore, the laser preferably has a power in the range of about 1 Watt to about 100 Watt, more preferably in the range of about 20 Watt to about 50 Watt, and more preferably about 30 Watt.

For a more complete understanding of the invention and the advantages thereof, exemplary embodiments of the invention are explained in more detail in the following description with reference to the accompanying drawing figures, in which like reference characters designate like parts and in which:

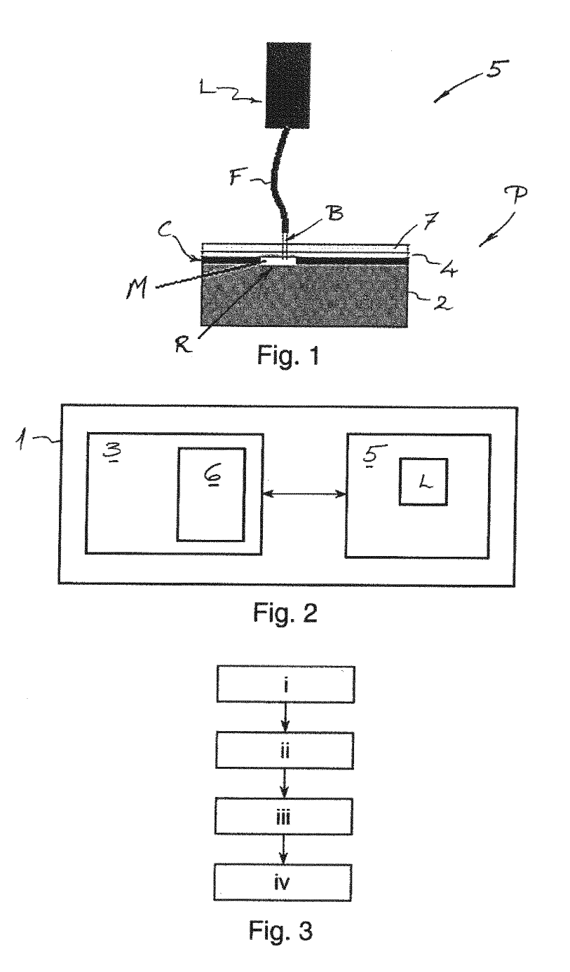

FIG. 1 is a partial schematic side view of part of an apparatus for marking a package of articles according to an embodiment of the invention;

FIG. 2 is a schematic illustration of an apparatus for marking a package of articles according to an embodiment of the invention; and

FIG. 3 is a flow chart which represents a method of marking a package of articles according to an embodiment of the invention.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not actually required. It will also be understood that the terms and expressions used in the present specification have the ordinary meaning as is accorded to such terms and expressions with respect to their corresponding respective areas of inquiry and study, except where specific meanings have otherwise been set forth herein.

With reference to FIG. 1 and FIG. 2 of the drawings, an apparatus 1 for marking a package of articles, such as a pack P of cigarettes (not shown), according to an embodiment of the invention is illustrated. The pack P comprises an enclosure 2, especially a box-like container, typically comprised of paper, cardboard, or card, that accommodates the cigarettes. The apparatus 1 comprises a wrapping unit 3 which is configured to wrap the pack P of cigarettes with a first wrapping material 4 such that the first wrapping material 4 substantially fully covers or encompasses the box-like container or enclosure 2. Further, the apparatus 1 includes a marking unit 5 comprising a laser L for irradiating the wrapped pack P with a laser beam B to provide a marking M on a region R of the enclosure 2 to be marked. In this embodiment, the marking M may, for example, include a batch code and/or expiry data specific to the packaged cigarettes. Furthermore, in this embodiment, the first wrapping material 4 comprises a polymer film, such as a polypropylene film, and is substantially transparent to the laser beam B, such that the film 4 remains largely unaffected by the laser beam B.

As can be seen in FIG. 1, the laser beam B generated by the laser L is irradiated onto the wrapped package P via a wave guide, and especially via an optical fibre F such that the laser L may be a fibre laser. The laser beam B generated by the laser L typically has a discrete or specific wavelength, which may be in the range of about 1000 μm to 1100 μm, and is preferably about 1062 μm. Furthermore, the laser L preferably has a power in the range of about 20 to 50 W, e.g. about 30 W. Because the outer surface of the pack P of cigarettes, at least in the region R to be marked, includes a coating C, such as an ink layer, which is sensitive to irradiation with the laser beam B, the laser L of the marking unit 5 is configured to mark or inscribe that region R of the box-like container 2 of the cigarette pack P when it is projected or irradiated on that region R through the film of polypropylene wrapping material 4. The marking may, for example, occur by the removal of the coating C by the laser beam B, which in turn generates contrast by exposing the substrate below the coating C.

Referring to FIG. 2, it will be seen that the apparatus 1 further includes a bundling unit 6 for collecting and arranging a plurality of separately or individually wrapped packs P from the wrapping unit 3 into a group and wrapping that group of packs P in a second wrapping material 7. In this regard, the bundling unit 6 optionally comprises a part of the wrapping unit 3, such that the plurality of packs P are only ready to be marked with the laser L of the marking unit 5 after those packs P have been wrapped as a group. Accordingly, the second wrapping material 7 is typically also substantially transparent to the laser beam B and comprises a polypropylene film substantially the same as the first wrapping material 4. The thickness of the first material and the second material is preferably in the range of about 5 μm to about 75 μm, and more preferably in the range of about 18 μm to about 25 μm. In one embodiment, the group of packs P wrapped with the second material 7 may need to be transferred or transported to the marking unit 5.

Finally, with reference now to FIG. 3 of the drawings, a flow diagram is shown that schematically illustrates steps in a method of marking a pack P of smoking articles according to a preferred embodiment of the invention as described above with respect to FIG. 1 and FIG. 2. In this regard, the first box i of FIG. 3 represents the step of providing a pack P of smoking articles, such as cigarettes, with the pack P comprising an enclosure 2, and especially a container, that accommodates the cigarettes. The second box ii represents a step of providing a first wrapping film 4 and wrapping the pack P with the first wrapping film 4 such that it covers at least a region R of the pack to be marked, and preferably substantially entirely covers the pack P. The third box iii then represents the step of collecting and/or arranging a plurality of the wrapped packs P into a group and wrapping that group of pre-wrapped packs P with a second wrapping material 7, so that the second wrapping material 7 substantially entirely covers or encompasses the whole group of the packs P. The final box iv in FIG. 3 represents the step of providing a marking M on the region R of the enclosure 2 of each pack P after wrapping the group of packs P with the second wrapping film 7. This step of marking the region R of the enclosure 2 of each pack P includes irradiating each wrapped pack P with a laser beam B to create the marking M, whereby both of the first and second wrapping materials 4, 7 are substantially transparent to and/or unaffected by the laser beam. After this, the method may further include the step of transferring or transporting the group of marked packs P to a dispatch station for final packing in a shipping carton for dispatch to customers.

Although specific embodiments of the invention have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In this document, the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

### LIST OF REFERENCE SIGNS

1 apparatus
2 enclosure or container
3 wrapping unit
4 first wrapping material
5 marking unit
6 bundling unit
7 second wrapping material
P package or pack
L laser
B laser beam
R region to be marked
M marking
C coating

1. A method of marking a package of articles, the method comprising the following method steps:
providing a package of one or more articles, the package comprising an enclosure that accommodates the one or more articles;
providing a first wrapping material and wrapping the package with the first wrapping material; and
providing a marking on a region of the enclosure after wrapping the package with the first wrapping material;
wherein the step of providing a marking on the region of the enclosure comprises irradiating the wrapped package with a laser beam, wherein the first wrapping material is substantially transparent to the laser beam, at least in the region to be marked.

2. The method of claim 1, wherein the region of the enclosure includes a surface or coating which is sensitive to irradiation with the laser beam, such that the laser beam marks the region.

3. The method of claim 1, wherein a plurality of the packages are provided and wrapped with the first wrapping material, the method further comprising:
at least one of collecting and arranging the plurality of wrapped packages into a group; and
providing a second wrapping material and wrapping the group of wrapped packages with the second wrapping material before the step of providing a marking on a region of the enclosure of at least one, and preferably each, wrapped package;
wherein the second wrapping material is substantially transparent to the laser beam, at least in each region.

4. The method of claim 1, wherein at least one of the first wrapping material and the second wrapping material is substantially unaffected by the laser beam.

5. The method of claim 1, wherein the enclosure of the package comprises a material selected from the group of: paper, card, cardboard, and plastic.

6. The method of claim 1, wherein the laser beam has a wavelength in the range of about 1000 μm to 1100 μm.

7. The method of claim 1, wherein the laser beam has a power in the range of about 1 W to about 100 W.

8. The method of claim 1, wherein the laser beam is irradiated onto the wrapped package via one or more wave guides and via one or more optical fibres.

9. The method of claim 1, wherein at least one of the first wrapping material and the second wrapping material is selected from the group consisting of: polypropylene, polyethylene, polyester, polyvinylchloride, and bioplastic such as polylactic acid, cellulose acetate, and cellophane.

10. The method of claim 1, wherein the marking provided with the laser beam comprises at least one of a code and data specific to the one or more articles.

11. A wrapped package of one or more articles, wherein the package comprises a laser marking obtained by a method, comprising the method steps:
providing a package of one or more articles, the package comprising an enclosure that accommodates the one or more articles;
providing a first wrapping material and wrapping the package with the first wrapping material; and
providing a marking on a region of the enclosure after wrapping the package with the first wrapping material;
wherein the step of providing a marking on the region of the enclosure comprises irradiating the wrapped package with a laser beam, wherein the first wrapping material is substantially transparent to the laser beam, at least in the region to be marked.

12. An apparatus for marking a package of articles, wherein the package comprises an enclosure which accommodates the articles, wherein the package is wrapped with a wrapping material that substantially surrounds the enclosure; the apparatus comprising:
a marking unit comprising a laser for irradiating the wrapped package with a laser beam to provide a marking on a region of the enclosure, wherein the wrapping material is substantially transparent to the laser beam, at least in the region to be marked.

13. The apparatus of claim 12, wherein the laser generates a laser beam having at least one of a wavelength in the range of about 1000 μm to 1100 μm, and a power in the range of about 1 W to 100 W.

14. The apparatus of claim 12, comprising a wrapping unit that is configured to wrap the package with the wrapping material, so that the wrapping material substantially covers or surrounds the enclosure.

15. The apparatus of claim 12, comprising a bundling unit comprised in the wrapping unit for at least one of collecting and arranging a plurality of packages into a group and wrapping the group of packages in the wrapping material.

16. The method of claim 2, wherein the surface or coating of the region includes an ink layer that is sensitive to the laser beam.

17. The method of claim 3, wherein the plurality of the packages are provided individually or separately wrapped with the first wrapping material.

18. The method of claim 4, wherein at least one of the first wrapping material and the second wrapping material is neither burnt nor broken by the laser beam.

19. The method of claim 1, wherein the laser is a fiber laser.

20. The method of claim 1, wherein the laser beam is irradiated onto the wrapped package as an image via a stencil, diaphragm, or screen.

21. The apparatus of claim 15, wherein the bundling unit is comprised in the wrapping unit and is configured to wrap the group of packages in the wrapping material.
